(19) United States
(12) Patent Application Publication
(10) Pub. No.: US 2015/0163326 A1
(43) Pub. Date: Jun. 11, 2015

(54) APPROACHES FOR REMOTELY UNZIPPING CONTENT

(71) Applicant: DROPBOX, INC., San Francisco, CA (US)

(72) Inventors: Matteus Pan, San Francisco, CA (US); Ziga Mahkovec, San Francisco, CA (US)

(73) Assignee: DROPBOX, INC., San Francisco, CA (US)

(21) Appl. No.: 14/099,694

(22) Filed: Dec. 6, 2013

(51) Int. Cl. H04L 29/06

(52) U.S. Cl. CPC H04L 69/04

(57) ABSTRACT

Various embodiments provide a method for enabling access to content of a compressed content item from a variety of computing devices. For example, upon receiving a compressed content item, an online content management system can decompress the compressed content item. A copy of the decompressed content item, in this example, can then be sent to one or more computing devices associated with the online content management system through a user account. Accordingly, when the compressed content item is uploaded and decompressed by the online content management system, a folder, for example, containing content associated with the online content management system is synced across each device associated with the user account with the decompressed content item, thereby, enabling the decompressed content item to be available on each device.

### TECHNICAL FIELD

The present technology pertains to unzipping compressed content items, and more specifically pertains to enabling users to unzip compressed files without having to locally download the compressed file.

### BACKGROUND

Compressing a file reduces the overall number of bits or bytes enabling the file to be transmitted faster over an Internet connection or causing the file to occupy less space on a disk. Once a compressed file is downloaded, a computer uses a program to expand the file back to its original size. For example, .zip is an archive file format that supports lossless data compression, which is a class of data compression algorithms that allow for the exact original data of the file to be reconstructed from the compressed data. Accordingly, .zip files (and the like) may contain one or more compressed files or folders.

Conventional approaches, however, require a compressed file, such as a .zip file, to be downloaded to a client device and, subsequently, decompressed using a program running locally on the client device. This is often inconvenient for users who may not already have such an unzip, extraction, or decompression program installed on their device. Further, such programs are not available for some computing devices, such as mobile computing devices, which require users to send the compressed file to a second device with compression/extraction capabilities and then send the decompressed files back to the mobile computing device.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In at least one embodiment, a user receiving a share link to view a compressed content item, such as a .zip, can view the compressed content item in a web browser or mobile application without locally downloading and decompressing the content item. For example, upon receiving a request to share a content item in a compressed form, an online content management system can decompress the content item to enable the content item in the decompressed form to be displayed on a computing device identified in the request. Accordingly, the computing device can display the content item without locally downloading the content item in the compressed form.

In at least one embodiment, upon receiving a compressed content item uploaded by a user, the online content management system can decompress, extract, or unzip the compressed content item. A copy of the decompressed content item, in this example, can then be sent to a first and a second computing device associated with the online content management system through a user account. In this example, the first and second computing devices can include a client-side application associated with the online content management system that communicates with the system to synchronize data stored locally on each computing device with data stored in the online content management system. Accordingly, when the compressed content item is uploaded and decompressed by the online content management system, the decompressed content can be synchronized across each device authorized on the user account.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A-1F shows a conventional process of a user attempting to view compressed content on a computing device;

FIGS. 2A-2E shows an exemplary process of a user uploading and viewing compressed content on a computing device in accordance with at least one embodiment;

FIG. 3 shows an example process in accordance with at least one embodiment;

FIG. 4 shows an exemplary configuration of devices and a network in accordance with the invention;

FIG. 5 shows an exemplary configuration of devices and a network in accordance with the invention;

FIG. 6A shows a conventional system bus computing system architecture; and

FIG. 6B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The disclosed technology addresses the need in the art for enabling access to content contained in a compressed content item that is generally only viewable after decompressing the content item. For example, a user can upload a compressed content item to an account on a content management system. To view the compressed content item through a web browser, or on a mobile computing device, the user would have to download the compressed content item to a second device with an appropriate decompression application and then re-upload the decompressed content item to the web browser or mobile computing device. The present technology addresses this limitation by including decompressed functionality in the content management system so that a user can still view the contents of a compressed content item though the web browser or on devices that lack decompression functionality, like mobile devices.

Various other functions and advantages are described and suggested below as may be provided in accordance with the various embodiments.

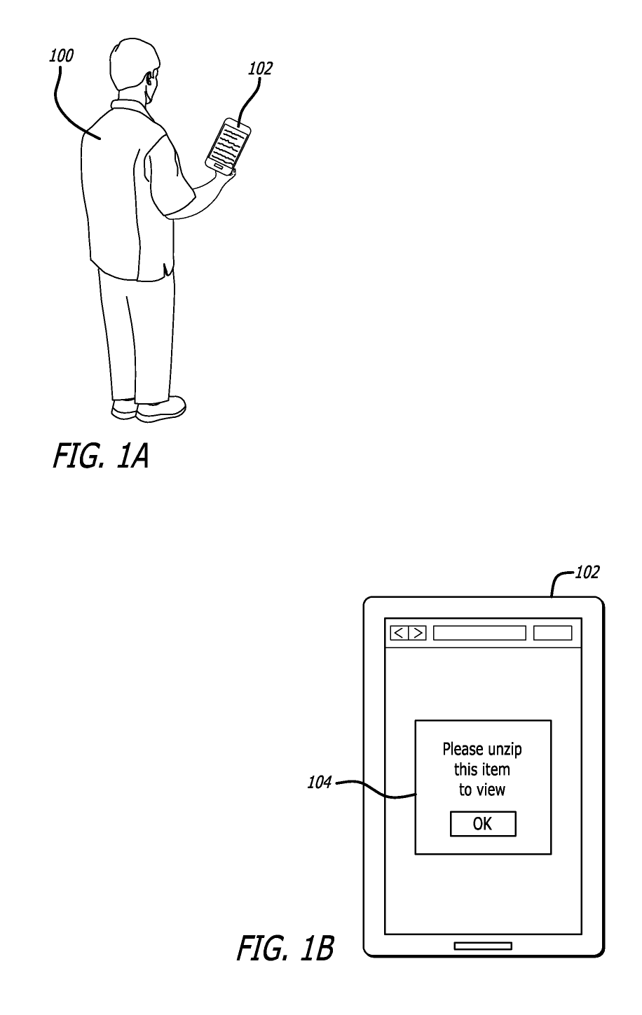

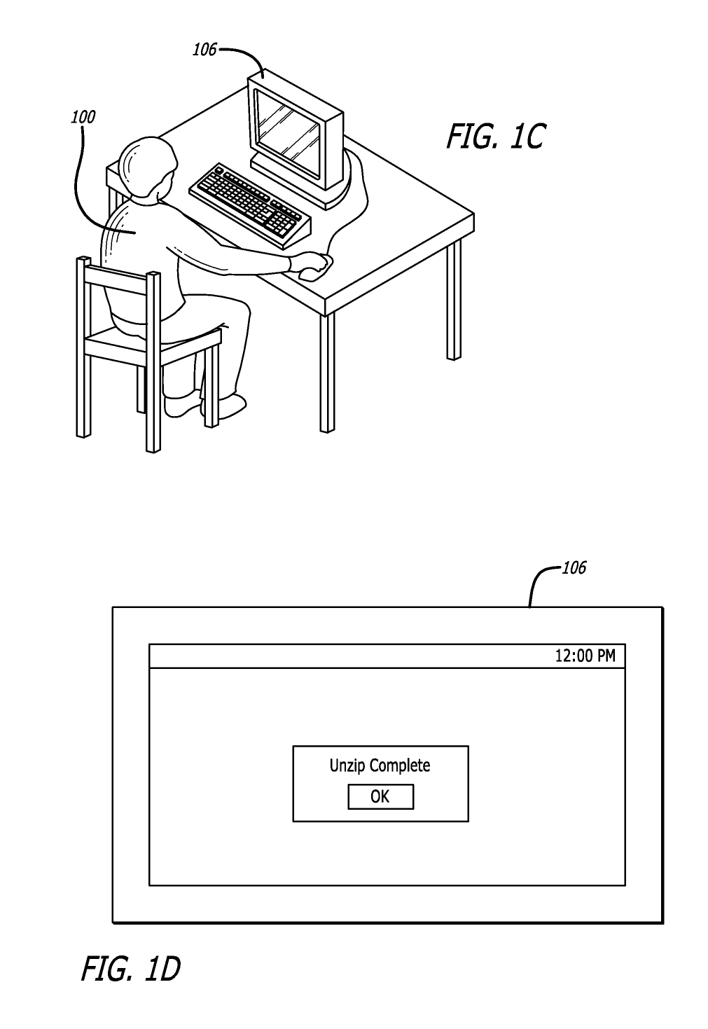

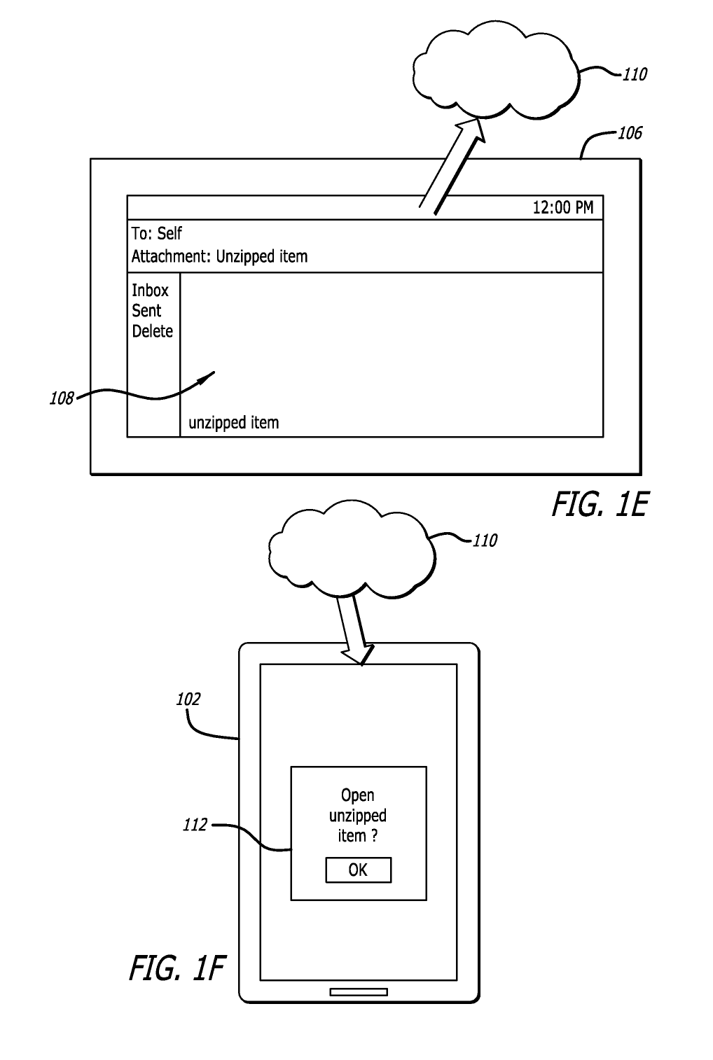

FIG. 1A shows an example of user 100 holding computing device 102 and FIG. 1B shows a top view of computing device 102. In this example, user 100 is attempting to view the contents of a compressed content item through computing device 102, which is a tablet computer. Since the content item is compressed, however, user 200 is prompted 104 to unzip or decompress the content item to enable viewing. As used herein, a compressed content item or zip file, such as a .zip, .tar, or .zipx file, can be a single file or content item (sometimes referred to as “archives”) that may contain one or more compressed files or content items. A compressed content item enables related content items to be kept together and further makes transporting, emailing, downloading, and storing data and software faster and more efficient.

Utilizing conventional approaches, user 100 will not be able to unzip the compressed content item on computing device 102. In this example, user 100 must download or send (i.e., email) the content item to a second computing device, such as computing device 106 shown in FIG. 1C. In this example, user 100, using a decompression program running locally on computing device 106, unzips, expands, or decompresses the content item, as shown by the prompt that the unzip is complete in FIG. 1D.

In order to view the content item on computing device 102, however, user 100 must resend the content item from computing device 106 to computing device 102. Accordingly, as shown in FIG. 1E, user 100 has attached the decompressed content item to email 108 to send to themselves through network 110 in order to then be able to open email 108 and view the decompressed content item on computing device 102. Finally, FIG. 1F shows prompt 112 asking user 100 if they want to open the decompressed content. In this example, upon selecting “ok”, the decompressed content item will be provided to user 100 for viewing.

Such a process to view the content item is inconvenient and cumbersome. Additionally, decompression programs are often not freely available, thereby, requiring user 100 to first download the compressed content item to computing device 106, purchase and download a decompression program, and then run the program to extract the content item before being able to view the content. It is further inconvenient that user 100 cannot decompress and immediately view the content item on computing device 102. Accordingly, there is a need for automatically enabling access to content of a compressed content item from a variety of computing devices.

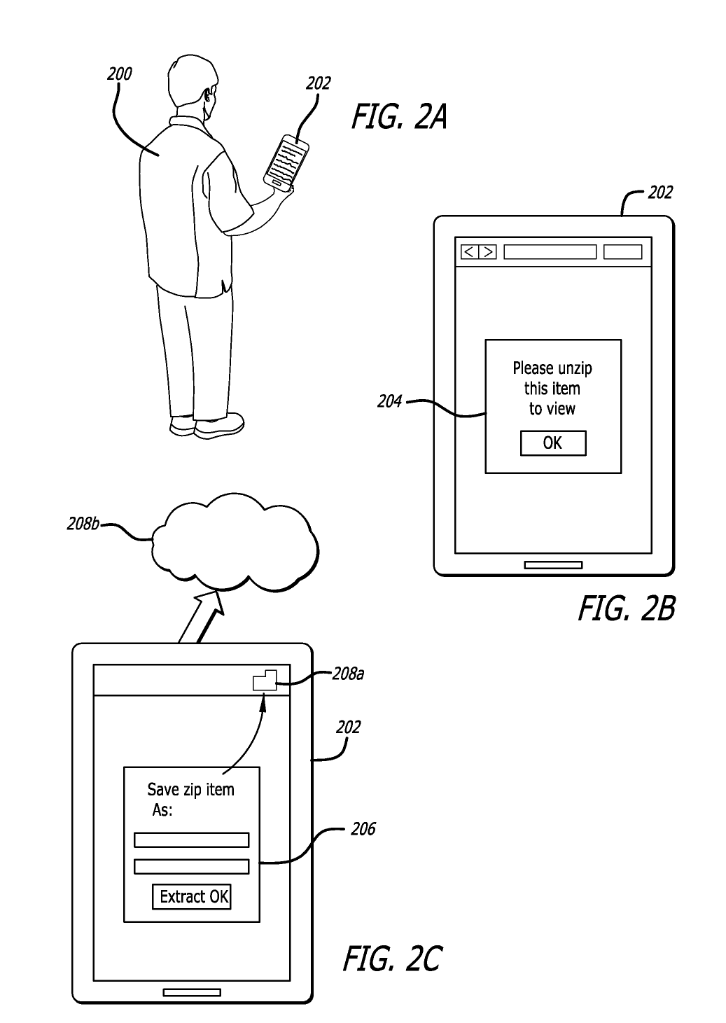

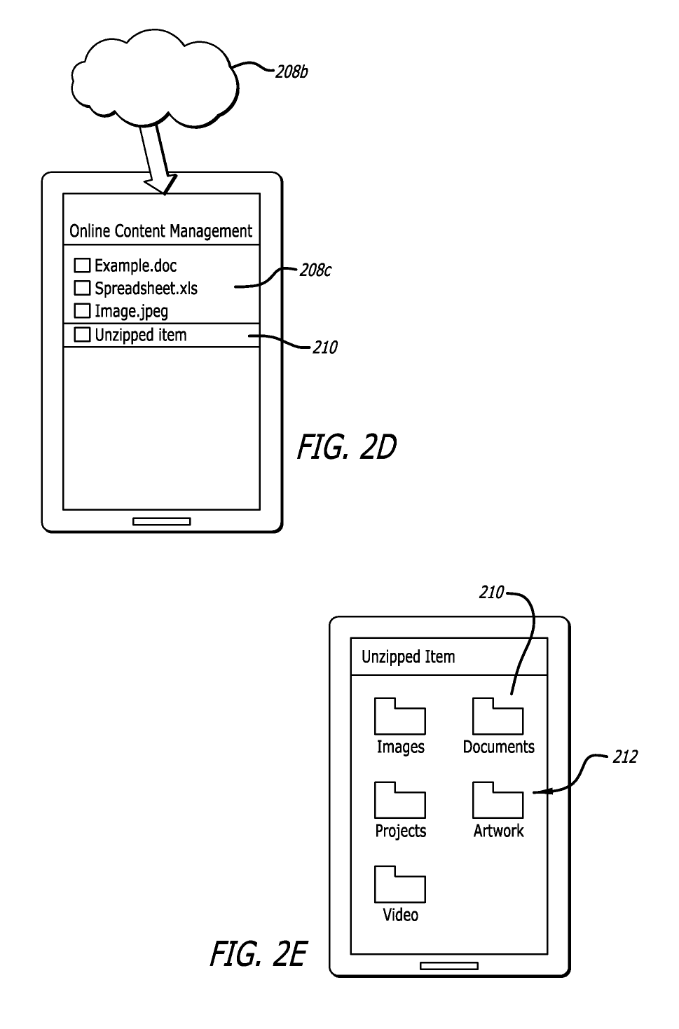

Similar to the above example, FIG. 2A shows an example of user 200 holding computing device 202 and FIG. 2B shows a top view of computing device 202 which shows prompt 204 for user 200 to unzip or decompress the content item for viewing. Although a mobile computing device (e.g., a smartphone, an electronic book reader, or tablet computer) is shown, it should be understood that any device capable of receiving and processing input can be used in accordance with various embodiments discussed herein. The devices can include, for example, desktop computers, notebook computers, electronic book readers, personal data assistants, cellular phones, video gaming consoles or controllers, television set top boxes, and portable media players, among others.

In at least one embodiment, computing device 202 is associated with online content management system 208b which, as used herein, can enable user 200 to upload and save a content item to one or more databases in a cloud computing environment. In this example, online content management system 208b can store a universal copy of the content item and enable user 200 to modify the content item from any number of computing devices, such as computing device 202, through a personalized account. Computing device 202 (and any other device authorized on the personalized account), in this example, can include client-side application 208a that communicates with online content management system 208b to synchronize a copy of the content item stored locally on computing device 202 (and any other device associated with the personalized account) with the universal copy of the content item stored with online content management system 208b.

Accordingly, in this example, the content item is a compressed content item and user 200 must first decompress the compressed content item (or cause it to be decompressed) before viewing the same. In accordance with various embodiments, user 200 can save 206 the compressed content item with online content management system 208b by uploading the same though client-side application 208a. In this example, upon identifying the content item as being a compressed content item, online content management system 208b can automatically extract, unzip, or decompress the compressed content item using a decompression program or algorithm. The particulars of the decompression program or algorithm are well known and will not be discussed in detail herein. Alternatively, the compressed content item can be saved decompressed by online content management system 208b upon receiving a command from user 200. Online content management system 208b can be configured to temporarily save the decompressed content for viewing during a current user session. For example, the decompressed content can be saved as long as the user remains connected via a web browser, then the decompressed content can be deleted so that it does not occupy space in the user's account. Alternatively, the decompressed content can be added to the user's account and synchronized to other mobile devices authorized on the user's account. Further the user 200 may want to decompress the content item on the content management system and then only synchronize and store locally only a few items contained within the content item to computing device 202.

In this example, once the content item has been decompressed and saved with online content management system 208b, the decompressed content item can then be available for display on computing device 202. FIG. 2D shows folder 208c that contains the content items that user 200 has stored with online content management system 208b. In this example, folder 208c can be opened when user 200 selects the icon of client-side application 208a, as shown in FIG. 2E. Accordingly, user 200 can open compressed content item 210 to view content 212 of the same. In this example, content item 210 includes multiple folders each containing content 212 for a different type of media that can be compressed into a single compressed content item.

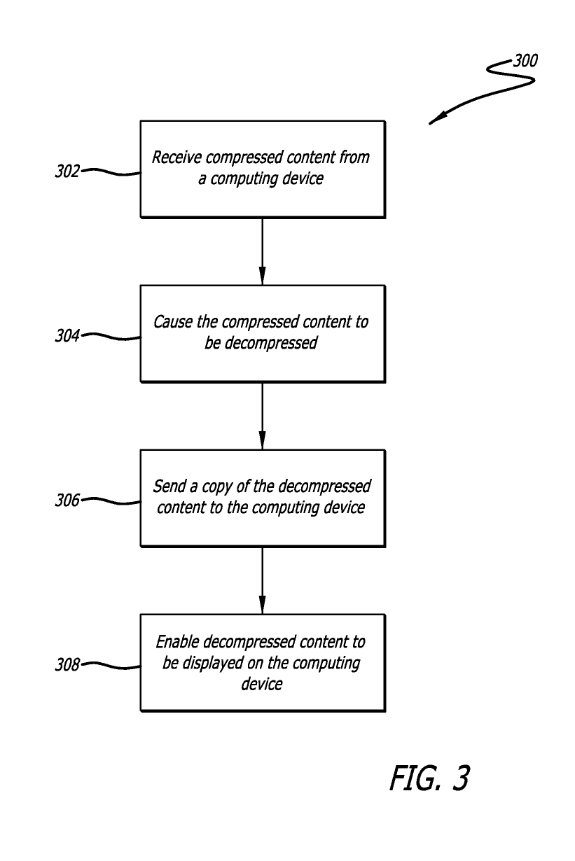

FIG. 3 illustrates an example process 300 for enabling access to content of a compressed content item from a variety of computing devices, in accordance with various embodiments. It should be understood that, for any process discussed here, there can be additional, fewer, or alternative steps performed in similar or alternative orders, or in parallel, within the scope of the various embodiments unless otherwise stated.

In this example, an online content management system receives a compressed content item from a computing device 302. Here, the computing device can include a client-side application that communicates with the online content management system to synchronize a copy of the received compressed content item stored locally on the computing device with data stored with the online content management system. Further, the online content management system will also communicate with any other computing devices, through a respective client-side application, associated with a user account to synchronize a copy of the received compressed content item locally on each computing device.

Upon receiving the compressed content item or upon user request, the online content management system can decompress, unzip, or extract the contents of the compressed content item using a decompression program or algorithm 304. In this example, the compressed content item can be one or a combination of multiple content items, such as a word processing document, a spreadsheet, a presentation, an image, a video, and the like. As mentioned above, the particulars of compression and decompression algorithms or programs are well known and will not be discussed in detail. Alternatively, upon being received and saved with online content management system, the compressed content item may only be decompressed upon receiving a command from user.

After the compressed content item has been decompressed, the online content management system may synchronize data associated with the content item, such as a copy of the decompressed content item, to the computing device 306. In this example, the computing device locally stores a copy of the decompressed content item which will be synchronized with data for the content item stored with the online content management system when changes are made thereto. In this example, once a copy of the decompressed content item is stored locally on the computing device either automatically or by user election, the content item can be displayed on the computing device 308. Accordingly, the computing device can display the content item locally without having to locally download the content item in the compressed form. Various other approaches can be used as well as discussed or suggested elsewhere herein.

In at least one embodiment, a copy of the decompressed content item need not necessarily be synchronized for local storage on the computing device. In this example, a compressed content item is decompressed by the online content management system and stored in a temporary buffer or repository where the decompressed content item is made available to the user through various devices registered to the user's account. In this example, a user could choose to locally store the decompressed content item or a portion of the decompressed content item on the computing device by selecting the decompressed content item or the portion of the decompressed content item for download from the temporary buffer or repository. Accordingly, the user could specify settings which require the user to select or choose to locally download the decompressed content item or the portion of the decompressed content item. Alternatively, the user could specify settings to automatically synchronize the decompressed content item for local storage on each device or a subset of devices on a user account.

The ability to remotely decompress and temporarily store a content item in a temporary repository of the online content management system can, in one embodiment, enable a user to search through content that may be stored within a compressed content item. For example, a user could search for a particular content item title and compressed content items can be decompressed and searched without the user having to decompress, locally store, and search each compressed content item. In this example, upon receiving a search request, the online content management system can search the title of each content item and can decompress compressed content items in the temporary repository, search the title or content of each item within the compressed content item, and disregard the contents of the temporary repository at a later time.

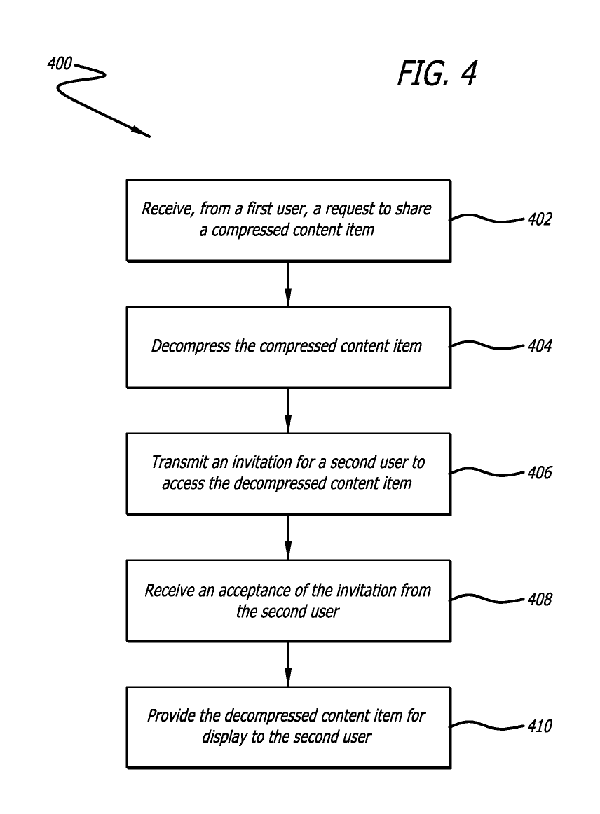

FIG. 4 illustrates an example process 400 for enabling a user to provide access to content of a compressed content item to another user, in accordance with various embodiments. In this example, a request from a first user to share a compressed content item is received 402. In this example, the compressed content item is decompressed 404. Accordingly, a request, from a computing device of the first user, to share a copy of the compressed content with the second user can be received and the online content management system, which can decompress the content item and send an invitation to view the decompressed content to the additional computing device.

In this example, the online content management system transmits an invitation for the second user to access the content of the content item after the compressed content item has been decompressed 406. Upon receipt and acceptance of the invitation, the decompressed content can be viewed on a computing device of the second user without having to locally download and decompress the compressed content. In this example, the invitation to access the decompressed content is accepted by the second user which is received by the online content management system 408. Accordingly, the decompressed content is provided for display to the second user which can be viewed through a mobile application, a web browser, or the like on the second user's computing device 410. Various other approaches can be used as well as discussed or suggested elsewhere herein.

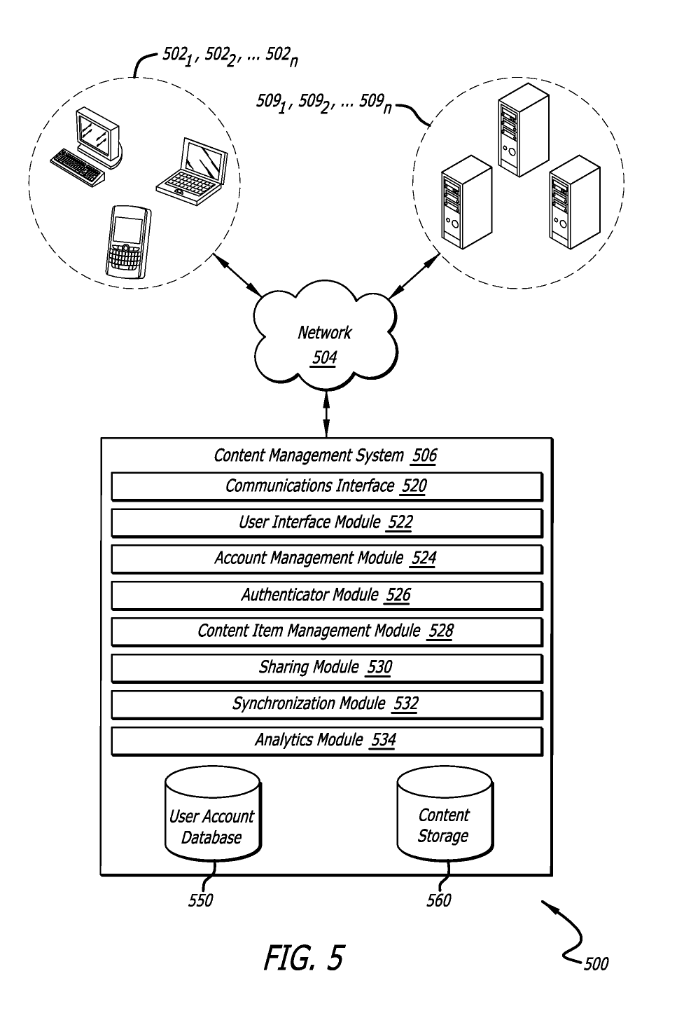

An exemplary system configuration 500 for enabling access to content of a compressed content item from a variety of computing devices is shown in FIG. 5, wherein computing devices communicate via a network for purposes of exchanging content and other data. The system can be configured for use on a wide area network such as that illustrated in FIG. 5. However, the present principles are applicable to a wide variety of network configurations that facilitate the intercommunication of electronic devices. For example, each of the components of system 500 in FIG. 5 can be implemented in a localized or distributed fashion in a network.

In system 500, a user can interact with content management system 506 through computing devices 502₁, 502₂, . . . , 502ₙ (collectively “502”) connected to network 504 by direct and/or indirect communication. Content management system 506 can support connections from a variety of different computing devices, such as desktop computers; mobile computers; mobile communications devices, e.g. mobile phones, smart phones, tablets; smart televisions; set-top boxes; and/or any other network enabled computing devices. Computing devices 502 can be of varying type, capabilities, operating systems, etc. Furthermore, content management system 506 can concurrently accept connections from and interact with multiple computing devices 502.

A user can interact with content management system 506 via a client-side application installed on computing device 502ᵢ. In some embodiments, the client-side application can include a content management system specific component. For example, the component can be a stand-alone application, one or more application plug-ins, and/or a browser extension. However, the user can also interact with content management system 506 via a third-party application, such as a web browser, that resides on computing device 502ᵢ and is configured to communicate with content management system 506. In either case, the client-side application can present a user interface (UI) for the user to interact with content management system 506. For example, the user can interact with the content management system 506 via a client-side application integrated with the file system or via a webpage displayed using a web browser application.

Content management system 506 can make it possible for a user to store content, as well as perform a variety of content management tasks, such as retrieve, modify, browse, and/or share the content. Furthermore, content management system 506 can make it possible for a user to access the content from multiple computing devices 502. For example, computing device 502ᵢ can upload content to content management system 506 via network 504. The content can later be retrieved from content management system 506 using the same computing device 502ᵢ or some other computing device 502ⱼ.

To facilitate the various content management services, a user can create an account with content management system 506. The account information can be maintained in user account database 550. User account database 550 can store profile information for registered users. In some cases, the only personal information in the user profile can be a username and/or email address. However, content management system 506 can also be configured to accept additional user information.

User account database 550 can also include account management information, such as account type, e.g. free or paid; usage information, e.g. file edit history; maximum storage space authorized; storage space used; content storage locations; security settings; personal configuration settings; content sharing data; etc. Account management module 524 can be configured to update and/or obtain user account details in user account database 550. The account management module 524 can be configured to interact with any number of other modules in content management system 506.

An account can be used to store content, such as digital data, documents, text files, audio files, video files, etc., from one or more computing devices 502 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 560. Content storage 560 can be a storage device, multiple storage devices, or a server. Alternatively, content storage 560 can be a cloud storage provider or network storage accessible via one or more communications networks. Content management system 506 can hide the complexity and details from computing devices 502 so that computing devices 502 do not need to know exactly where the content items are being stored by content management system 506. In one variation, content management system 506 can store the content items in the same folder hierarchy as they appear on computing device 502ᵢ. However, content management system 506 can store the content items in its own order, arrangement, or hierarchy. Content management system 506 can store the content items in a network accessible storage (SAN) device, in a redundant array of inexpensive disks (RAID), etc. Content storage 560 can store content items using one or more partition types, such as FAT, FAT32, NTFS, EXT2, EXT3, EXT4, ReiserFS, BTRFS, and so forth.

Content storage 560 can also store metadata describing content items, content item types, and the relationship of content items to various accounts, folders, or groups. The metadata for a content item can be stored as part of the content item or can be stored separately. In one variation, each content item stored in content storage 560 can be assigned a system-wide unique identifier.

Content storage 560 can decrease the amount of storage space required by identifying duplicate files or duplicate segments of files. Instead of storing multiple copies, content storage 560 can store a single copy and then use a pointer or other mechanism to link the duplicates to the single copy. Similarly, content storage 560 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 506 can be configured to support automatic synchronization of content from one or more computing devices 502. The synchronization can be platform agnostic. That is, the content can be synchronized across multiple computing devices 502 of varying type, capabilities, operating systems, etc. For example, computing device 502ᵢ can include client software, which synchronizes, via a synchronization module 532 at content management system 506, content in computing device 502ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 506. Conversely, the background process can identify content that has been updated at content management system 506 and synchronize those changes to the local folder. The client software can provide notifications of synchronization operations, and can provide indications of content statuses directly within the content management application. Sometimes computing device 502ᵢ may not have a network connection available. In this scenario, the client software can monitor the linked folder for file changes and queue those changes for later synchronization to content management system 506 when a network connection is available. Similarly, a user can manually stop or pause synchronization with content management system 506.

A user can also view or manipulate content via a web interface generated and served by user interface module 522. For example, the user can navigate in a web browser to a web address provided by content management system 506. Changes or updates to content in the content storage 560 made through the web interface, such as uploading a new version of a file, can be propagated back to other computing devices 502 associated with the user's account. For example, multiple computing devices 502, each with their own client software, can be associated with a single account and files in the account can be synchronized between each of the multiple computing devices 502.

Content management system 506 can include a communications interface 520 for interfacing with various computing devices 502, and can interact with other content and/or service providers 509₁, 509₂, . . . , 509ₙ (collectively “509”) via an Application Programming Interface (API). Certain software applications can access content storage 560 via an API on behalf of a user. For example, a software package, such as an app on a smartphone or tablet computing device, can programmatically make calls directly to content management system 506, when a user provides credentials, to read, write, create, delete, share, or otherwise manipulate content. Similarly, the API can allow users to access all or part of content storage 560 through a web site.

Content management system 506 can also include authenticator module 526, which can verify user credentials, security tokens, API calls, specific computing devices, and so forth, to ensure only authorized clients and users can access files. Further, content management system 506 can include analytics module 534 module that can track and report on aggregate file operations, user actions, network usage, total storage space used, as well as other technology, usage, or business metrics. A privacy and/or security policy can prevent unauthorized access to user data stored with content management system 506.

Content management system 506 can include sharing module 530 for managing sharing content publicly or privately. Sharing content publicly can include making the content item accessible from any computing device in network communication with content management system 506. Sharing content privately can include linking a content item in content storage 560 with two or more user accounts so that each user account has access to the content item. The sharing can be performed in a platform agnostic manner. That is, the content can be shared across multiple computing devices 502 of varying type, capabilities, operating systems, etc. The content can also be shared across varying types of user accounts.

In some embodiments, content management system 506 can include a content item management module 528 for maintaining a content directory. The content directory can identify the location of each content item in content storage 560. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 506 can use the content path to present the content items in the appropriate folder hierarchy.

A content entry can also include a content pointer that identifies the location of the content item in content storage 560. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 530 can be configured to add a user account identifier to the content entry associated with the content item, thus granting the added user account access to the content item. Sharing module 530 can also be configured to remove user account identifiers from a content entry to restrict a user account's access to the content item.

To share content publicly, sharing module 530 can be configured to generate a custom network address, such as a uniform resource locator (URL), which allows any web browser to access the content in content management system 506 without any authentication. To accomplish this, sharing module 530 can be configured to include content identification data in the generated URL, which can later be used to properly identify and return the requested content item. For example, sharing module 530 can be configured to include the user account identifier and the content path in the generated URL. Upon selection of the URL, the content identification data included in the URL can be transmitted to content management system 506 which can use the received content identification data to identify the appropriate content entry and return the content item associated with the content entry.

In addition to generating the URL, sharing module 530 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 530 can be configured to change the value of the flag to 6 or true after generating a URL to the content item.

In some embodiments, sharing module 530 can also be configured to deactivate a generated URL. For example, each content entry can also include a URL active flag indicating whether the content should be returned in response to a request from the generated URL. For example, sharing module 530 can be configured to only return a content item requested by a generated link if the URL active flag is set to 6 or true. Thus, access to a content item for which a URL has been generated can be easily restricted by changing the value of the URL active flag. This allows a user to restrict access to the shared content item without having to move the content item or delete the generated URL. Likewise, sharing module 530 can reactivate the URL by again changing the value of the URL active flag to 6 or true. A user can thus easily restore access to the content item without the need to generate a new URL.

While content management system 506 is presented with specific components, it should be understood by one skilled in the art, that the architectural configuration of system 506 is simply one possible configuration and that other configurations with more or less components are also possible.

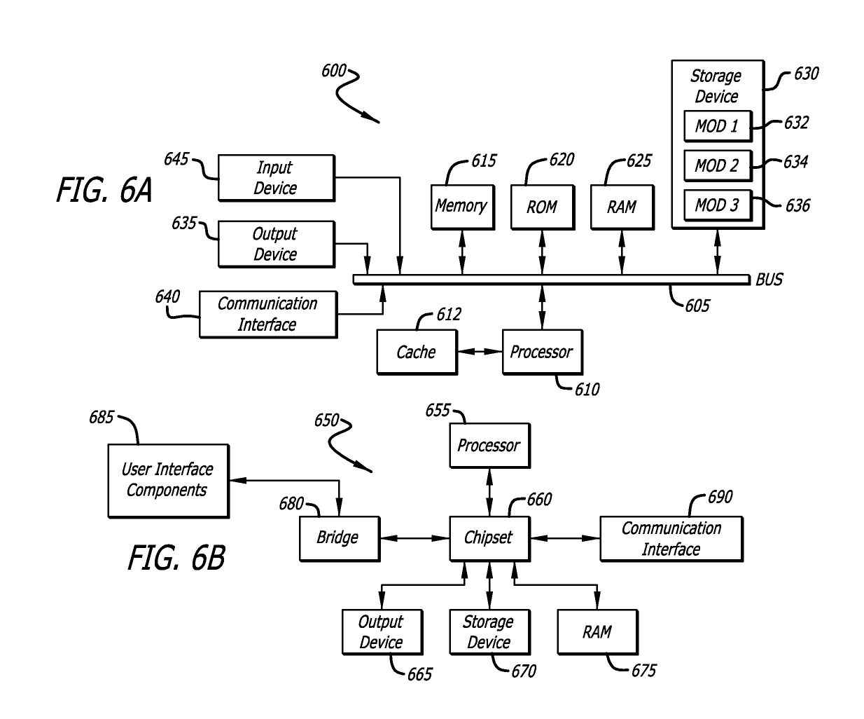

FIG. 6A, and FIG. 6B show exemplary possible system embodiments. The more appropriate embodiment will be apparent to those of ordinary skill in the art when practicing the present technology. Persons of ordinary skill in the art will also readily appreciate that other system embodiments are possible.

FIG. 6A shows a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B shows a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 650 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method, comprising:
under the control of one or more computer systems configured with executable instructions,
receiving, for storage in a user account in an online content management system, a compressed content item, contents of the compressed content item viewable only after decompressing the compressed content item;
in response to receiving a request from a client device to view the compressed content item, decompressing the compressed content item on the content management system; and
providing, for display on the client device, a listing of the decompressed content item.

2. The computer-implemented method of claim 1, wherein decompressing the compressed content item includes saving the decompressed content in the user account.

3. The computer-implemented method of claim 2, further comprising:
synchronizing the decompressed content item to at least one computing device authorized on the user account.

4. The computer-implemented method of claim 1, wherein decompressing the compressed content item includes temporarily saving, during an active user session, the decompressed content in the online content management system.

5. (canceled)

6. The computer-implemented method of claim 4, wherein the active user session is terminated by logging out of the user account through a web browser.

7. A non-transitory computer-readable storage medium storing instructions that, when executed by at least one processor, cause a computing device to:
receive, by an online content management system, compressed content uploaded from a computing device for storage, the computing device being associated with the online content management system through a user account;
cause the compressed content, stored with the online content management system, to be decompressed; and
send the decompressed content to the computing device for local storage.

8. The non-transitory computer-readable storage medium of claim 7, wherein the instructions that, when executed by the at least one processor, further cause the computing device to:
send the decompressed content to at least one additional computing device associated with the user account for local storage.

9. The non-transitory computer-readable storage medium of claim 7, wherein the computing device can display the decompressed content without locally decompressing the compressed content.

10. The non-transitory computer-readable storage medium of claim 7, wherein the instructions that, when executed by the at least one processor, further cause the computing device to:
receive, from the computing device, a request to share a copy of the decompressed content with an additional computing device; and
send an invitation to view the decompressed content to the additional computing device.

11. The non-transitory computer-readable storage medium of claim 10, wherein the instructions that, when executed by the at least one processor, further cause the computing device to:
enable, upon accepting the invitation, the decompressed content to be view on the additional computing device.

12. The non-transitory computer-readable storage medium of claim 7, wherein the computing device includes a client-side application that communicates with the online content management system to synchronize data stored locally on the computing device with data stored in the online content management system.

13. The non-transitory computer-readable storage medium of claim 7, wherein the compressed content comprises a plurality of content.

14. The non-transitory computer-readable storage medium of claim 7, wherein the decompressed content is viewable through at least one of a mobile application or a web browser.

15. A synchronized content management system, comprising:
at least one processor; and
memory including instructions that, when executed by the processor, cause the system to:
receive a compressed content item from a first client device for storage, the first client device being authorized on a user account; and
in response to receiving a request to view content of the compressed content item, decompressing the compressed content item.

16. The system of claim 15, wherein the instructions that, when executed by the at least one processor, further cause the system to:
receive, from the first client device, a request to share a copy of the decompressed content with a second client device;
send an invitation to view the decompressed content to the second client device; and
enable, upon accepting the invitation, the decompressed content to be view on the second client device.

17. The system of claim 15, wherein the system enables at least one of storing or modifying content from the first client device and a at least a second client device, each client device locally storing a copy of the content and communicating with the system to maintain a universal copy of the content locally stored on each client device.

18. The system of claim 15, wherein decompressing the compressed content item includes saving the decompressed content in the user account.

19. The system of claim 15, wherein decompressing the compressed content item includes temporarily, during an active user session, saving the decompressed content in the online content management system.

20. The system of claim 15, wherein the decompressed content is viewable through at least one of a mobile application or a web browser.
